(19) United States
(12) Patent Application Publication
(10) Pub. No.: US 2025/0349842 A1
(43) Pub. Date: Nov. 13, 2025

(54) CATHODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/033,923

(22) Filed: Jan. 22, 2025

(30) Foreign Application Priority Data
May 13, 2024 (JP) 2024-077865

(51) Int. Cl. H01M 4/525; H01M 4/02; H01M 4/505

(52) U.S. Cl. CPC H01M 4/525; H01M 4/505; H01M 2004/021; H01M 2004/028

(57) ABSTRACT

A cathode active material includes crystallites. The crystallites are present as single crystallites or a secondary particle. The secondary particle includes 2 to 20 crystallites. Each of the crystallites has a maximum Feret diameter of 1 μm or more. Either or both of the crystallite and the secondary particle have an open pore. The open pore has an opening diameter of 10 nm to 500 nm. A relation of “0.006≤L/D<0.500” is satisfied. “L” represents a path length of the open pore. When the crystallites are present as the single crystallites, “D” represents the maximum Feret diameter of the crystallite. When the crystallites are present as a secondary particle, “D” represents the maximum Feret diameter of the secondary particle.

### CROSS-REFERENCE TO RELATED APPLICATION

This application claims priority to Japanese Patent Application No. 2024-077865 filed on May 13, 2024, incorporated herein by reference in its entirety.

### BACKGROUND

### 1. Technical Field

The present disclosure relates to cathode active materials.

### 2. Description of Related Art

WO2022/137360 discloses a lithium composite oxide sintered plate having specific ranges of porosities, average pore sizes, and interface lengths.

### SUMMARY

A cathode active material includes crystallites. The crystallites may be present as secondary particles. The crystallites repeatedly expand and contract due to repeated charging and discharging. Strain may accumulate in the crystallites due to the volume change of the crystallites. The accumulation of strain may cause cracking in the crystallites. The cracking exposes nascent surfaces. A reaction of the nascent surfaces with an electrolyte is considered to accelerate a decrease in capacity. That is, such a reaction is considered to decrease durability.

An object of the present disclosure is to improve durability.
1. A cathode active material includes crystallites. The crystallites are present as either single crystallites or a secondary particle. The secondary particle includes 2 to 20 crystallites. Each of the crystallites has a maximum Feret diameter of 1 μm or more. Either or both of the crystallite and the secondary particle have an open pore. The open pore has an opening diameter of 10 nm to 500 nm. A relation of “0.006≤L/D<0.500” is satisfied. “L” represents a path length of the open pore. When the crystallites are present as the single crystallites, “D” represents the maximum Feret diameter of the crystallite. When the crystallites are present as the secondary particle, “D” represents the maximum Feret diameter of the secondary particle.

In the present disclosure, either or both of the crystallite and the secondary particle has a shallow micropore. That is, the opening diameter of the open pore is 10 nm to 500 nm. Moreover, the ratio (L/D) of the path length of the open pore to the maximum Feret diameter of the secondary particle (or the crystallite) is 0.006 or more and less than 0.500. The shallow micropore can reduce a volume change of the crystallite. Accumulation of strain is thus reduced, so that durability is expected to be improved. If the ratio (L/D) is less than 0.006, the volume change of the crystallite may not be sufficiently reduced. If the radio (L/D) is 0.500 or more, durability may be reduced. This is considered to be because a deep micropore separates the particles and a buffer section that can absorb a volume change is narrow.
2. The cathode active material according to the above “1” may include, for example, the following configuration. A relation of 0.010≤L/D≤0.490 is satisfied.
3. The cathode active material according to the above “1” or “2” may include, for example, the following configuration. The open pore is open to a surface of the crystallite.
4. The cathode active material according to any one of the above “1” to “3” may include, for example, the following configuration. The open pore is open between the crystallites.
5. The cathode active material according to any one of the above “1” to “4” may include, for example, the following configuration. The open pore extends linearly.

An embodiment of the present disclosure (hereinafter also simply referred to as “present embodiment”) and an example of the present disclosure (hereinafter also simply referred to as “present example”) will be described. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally planned to extract any desired configurations from the present embodiment and combine them as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a cathode active material according to the present embodiment;

FIG. 2 is a conceptual diagram showing a central region and a peripheral region in the present embodiment;

FIG. 3 is a schematic flowchart of a method for producing a cathode active material according to the present embodiment;

FIG. 4 is a schematic diagram illustrating an exemplary fixture; and

FIG. 5 is a table showing experimental results.

### DETAILED DESCRIPTION OF EMBODIMENTS

### Terms and Phrases

Geometric terms should not be construed in a strict sense. Examples of the geometric terms include “parallel”, “vertical”, and “orthogonal”. For example, “parallel” may slightly deviate from “parallel” in a strict sense. For example, directions, angles, distances, and the like may be relatively displaced within a range in which substantially the same function is obtained. The geometric terms may include, for example, design-related, work-related, or manufacturing-related, tolerances, variations, and so forth. Dimensional relationships in each drawing may not match actual dimensional relationships. The dimensional relationships in the drawings may be changed to facilitate understanding by readers. For example, the length, width, thickness, and so forth, may be changed. Part of the configurations may be omitted.

Numerical ranges such as “m to n %” include upper and lower limits unless otherwise specified. That is, “m to n %” indicates a numerical range of “m % or more and n % or less”. In addition, “m % or more and n % or less” includes “more than m % and less than n %”. The terms “greater than or equal to” and “less than or equal to” are represented by an equal signed inequality sign “≤, ≥”. “Super” and “less than” are represented by inequality signs “<, >” that do not include equal signs.

All numerical values are modified by the term “approximately.” The term “approximately” can mean, for example, ±5%, ±3%, ±1%, and the like. All numerical values may be approximations that may vary depending on the application of the subject technology. All numerical values can be displayed with significant digits. The measured value may be an average value in a plurality of measurements unless otherwise specified. The number of measurements may be three or more, five or more, or 10 or more. In general, it is expected that the reliability of the average value improves as the number of measurements increases. The measured value can be rounded by rounding based on the number of significant digits. The measured value can include an error etc. associated with, for example, the detection limit of a measuring device.

For example, the expression “either or both of A and B” includes “A or B” and “A and B”. “Either or both of A and B” may also be referred to as “A and/or B.”

“Crystallite” refers to a solid particle having a boundary between particles that is the smallest unit of the particle and that is recognized as incapable of being further subdivided. “Secondary particle” refers to an aggregate of two or more crystallites. The crystallites forming the secondary particles may also be referred to as primary particles.

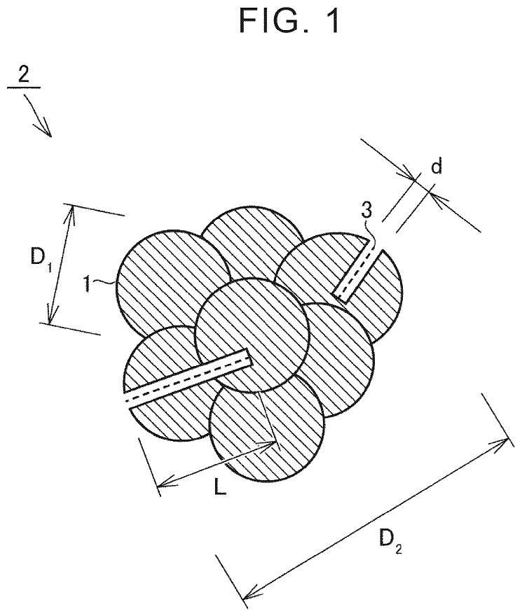

FIG. 1 is a conceptual diagram showing a cathode active material according to the present embodiment. The maximum Feret diameter (D₁) of the crystallite 1 is measured in the sectional SEM (Scanning Electron Microscope) of the secondary particle 2. The “maximum Feret diameter (D₂) of the secondary particle 2” is measured in the sectional SEM images of the secondary particle 2. The “opening diameter (d)” of the open pore 3 is measured in the sectional SEM image of the secondary particle 2. The “path length (L)” of the open pores 3 is measured in the sectional SEM image of the secondary particle 2. The observation magnification can be adjusted according to the particle size. The observation magnification may be, for example, about 1000 times. The sectional sample of the particles can be prepared by a conventionally known method. For example, CP (Cross Section Polisher), FIB (Focused Ion Beam) and the like may be used to prepare sectional samples. Various dimensions in the image are measured by image analysis software. For example, “ImageJ Fiji” or the like may be used. It should be noted that “ImageJ Fiji” is merely an example. Any image analysis software can be used as long as it has a function equivalent to “ImageJ Fiji”. For example, image analysis software attached to various SEM devices may be used.

“Maximum Feret diameter” refers to the distance between the two most distant points on the contour of the particle in the SEM image. When the crystallites 1 are present as single crystallites, “maximum Feret diameter (D)” indicates “maximum Feret diameter of the crystallite 1 (D₁)”. When the crystallites 1 are present as the secondary particle 2, the “maximum Feret diameter (D)” indicates the “maximum ferret diameter (D₂) of the secondary particle 2”.

In the sectional SEM image of the secondary particle 2, the surface of the secondary particles 2 is observed. A pore that communicates with the outside air is an “open pore 3”. The diameter of the opening of the open pore 3 is “opening diameter (d)”. The “communication pore” indicates an open pore 3 having a plurality of openings. In the case of the communication hole, the arithmetic mean value of the plurality of opening diameters is regarded as the “opening diameter (d)”.

When a plurality of open pores 3 is formed in the secondary particle 2, the longest path length is regarded as “path length (L)”. When the open pore is branched or the open pores are merged, the sum of all path lengths is considered “path length (L)”.

The “linearity” of the open pore 3 is obtained by the following equation. The closer the linearity is to 1, the more the open pore is considered to be linear.
S=L₀/L₁
S: Linearity
L₀: Path length of open pore 3 in sectional SEM image
L₁: linear distance between openings of open pore 3 in sectional SEM images (linear distance between inlet and outlet)

The stoichiometric composition formula represents a representative example of a compound. The compound may have a non-stoichiometric composition. For example, “Al₂O₃” is not limited to compounds having a material ratio (molar ratio) of “Al/O=2/3”. Unless otherwise noted, “Al₂O₃” refers to compounds containing Al and O at any molar ratio. For example, the compound may be doped with a trace element. Part of Al and O may be substituted with another element.

### Cathode Active Material

Hereinafter, the cathode active material in the present embodiment may be abbreviated as “the present cathode active material”. The cathode active material is for a secondary battery. That is, the present disclosure also provides a “cathode including the cathode active material” and a “secondary battery including the cathode active material”. The secondary battery may be, for example, a liquid-based battery, a polymer battery, or an all-solid-state battery. The secondary battery may be, for example, a monopolar battery or a bipolar battery.

The cathode active material is a powder. D50 of the cathode active material, for example, 0.1 μm or more, 1 μm or more, 5 μm or more, or 10 μm or more. D50 may be, for example, 30μμm or less, 25 μm or less, 20 μm or less, 15 μm or less, or 10 μor less. D50 can be measured, for example, by a laser diffraction method.

### Crystallite

As shown in FIG. 1, the cathode active material includes a crystallite 1. The crystallites 1 may be present as single crystallites. The crystallite 1 has a maximum Feret diameter of 1 μm or more. The maximum Feret diameter (D₁) of the crystallite 1 may be, for example, 1.5 μm or more, 2 μm or more, or 2.5 μm or more. The maximum Feret diameter (D₁) of the crystallite 1 may be, for example, 3 μm or less, 2.5 μm or less, 2 μm or less, or 1.5 μm or less.

The crystallite 1 may have, for example, an aspect ratio of 1 to 2. The aspect ratio may be, for example, 1.8 or less, 1.6 or less, 1.4 or less, or 1.2 or less. The aspect ratio may be, for example, 1.2 or more, 1.4 or more, 1.6 or more, or 1.8 or more. “Aspect ratio” is the ratio of the major axis diameter to the minor axis diameter. The major axis diameter represents the maximum Feret diameter. The minor axis diameter represents the minimum Feret diameter.

### Secondary Particle

The crystallites 1 may form the secondary particle 2. The secondary particle 2 includes 2 to 20 crystallites 1. When the number of crystallites 1 in the secondary particle 2 exceeds 20, for example, there is a possibility that the durability is lowered. The number of crystallites 1 included in the secondary particle 2 may be, for example, 15 or less, 10 or less, or 5 or less. The number of crystallites 1 included in the secondary particle 2 may be, for example, 5 or more, 10 or more, or 15 or more.

The maximum Feret diameter (D₂) of the secondary particle 2 may be, for example, 2 μm to 30 μm. The maximum Feret diameter (D₂) of the secondary particle 2 may be, for example, 3 μm or more, 6 μm or more, 9 μm or more, 12 μm or more, 15 μm or more, 18 μm or more, 21 μm or more, 24 μm or more, or 27 μm or more. The maximum Feret diameter (D2) of the secondary particle 2 may be, for example, 27 μm or less, 24 μm or less, 21 μm or less, 18 μm or less, 15 μm or less, 12 μm or less, 9 μm or less, or 6 μm or less.

### Open Pore

The open pore 3 is formed in either or both of the crystallite 1 and the secondary particle 2. The number of open pores 3 may be one or may be two or more. One open pore 3 may be branched. The plurality of open pores 3 may merge with each other. The number of open pores 3 included in one secondary particle 2 may be, for example, one or more, two or more, three or more, four or more, or five or more. The number of open pores 3 may be, for example, 10 or less, nine or less, eight or less, seven or less, six or less, five or less, or four or less.

The open pore 3 may be open to, for example, the surface of the crystallite 1. The open pore 3 may pass through, for example, the crystallite 1. The open pore 3 may terminate in, for example, the crystallite 1. The open pore 3 may be open between, for example, the crystallites 1. The open pore 3 may pass through, for example, the secondary particle 2. The open pore 3 may, for example, terminate in the secondary particle 2. The open pore 3 may be, for example, a communication pore. The communication pore has a plurality of openings in the secondary particle 2 (or the crystallite 1). In the secondary particle 2, the open pore 3 may not extend in the crystallite 1. For example, the open pore 3 may be a space between the crystallites 1. When a plurality of open pore 3 is formed in one secondary particle 2, both an open pore 3 extending in the crystallite 1 and an open pore 3 that is a space between the crystallites 1 may be formed. One open pore 3 may include both a path passing through the crystallite 1 and a path extending in a space between the crystallites 1.

The open pore 3 have an opening diameter (d). The opening diameter (d) is 10 to 500 nm. If the opening diameter (d) is less than 10 nm, the initial resistivity may be increased. When the opening diameter (d) exceeds 500 nm, for example, cracking may occur in the secondary particle 2 starting from the open pore 3. The opening diameter (d) may be, for example, 25 nm or more, 400 nm or more, 50 nm or more, 75 nm or more, 100 nm or more, 150 nm or more, 200 nm or more, 250 nm or more, 300 nm or more, 350 nm or more, or 450 nm or more. The opening diameter (d) may be, for example, 450 nm or less, 400 nm or less, 350 nm or less, 300 nm or less, 250 nm or less, 200 nm or less, 150 nm or less, 100 nm or less, 75 nm or less, 50 nm or less, or 25 nm or less.

In the present cathode active material, the relation of “0.006≤L/D<0.500” is satisfied. The ratio (L/D) is the ratio of the path length (L) of the open pore 3 to the maximum Feret diameter (D). L/D may be, for example, 0.010 or more, 0.025 or more, 0.050 or more, 0.075 or more, 0.086 or more, 0.100 or more, 0.200 or more, 0.300 or more, 0.400 or more, or 0.490 or more. L/D may be, for example, 0.490 or less, 0.400 or less, 0.300 or less, 0.200 or less, 0.100 or less, 0.086 or less, 0.075 or less, 0.050 or less, 0.025 or less, or 0.010 or less. That is, the relation of “0.010≤L/D≤0.490” may be satisfied.

The open pore 3 may extend, for example, in a curved manner. The open pore 3 may extend, for example, linearly. Since the open pore 3 is linear, durability may be improved. The open pore 3 may have, for example, a linearity of 1 to 1.5. The linearity may be, for example, 1.4 or less, 1.3 or less, 1.2 or less, 1.15 or less, 1.10 or less, or 1.05 or less. The linearity may be, for example, 1.05 or more, 1.1 or more, 1.15 or more, or 1.2 or more. The open pore 3 that extends linearly can be formed by, for example, hole machining described later.

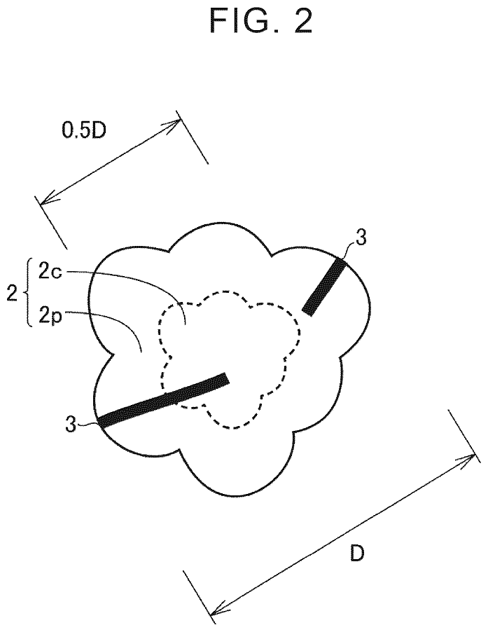

FIG. 2 is a conceptual diagram illustrating a central region and a peripheral region in the present embodiment. The section of the secondary particle 2 includes a central region 2c and a peripheral region 2p. The central region 2c is similar in shape to the contour of the secondary particle 2. The central region 2c has the same geometric center as the contour of the secondary particle 2. The maximum Feret diameter of the central region 2c is 0.5D. The section of the secondary particle 2 other than the central region 2c is the peripheral region 2p. The peripheral region 2p surrounds the central region 2c. In FIG. 2, the section of the secondary particle 2 is illustrated, but when the crystallites 1 are present as single crystallites, the section of the crystallite 1 includes the central region 2c and the peripheral region 2p.

For example, the open pore 3 may extend toward the central region 2c. For example, the open pore 3 may extend toward the geometric center of the secondary particle 2 (or the crystallite 1). For example, the open pore 3 may reach the central region 2c. For example, the open pore 3 may pass through the central region 2c. For example, the open pore 3 may not reach the central region 2c and terminate in the peripheral region 2p. Since the open pore 3 is appropriately shallow, durability may be improved. The maximum Feret diameter of the central region 2c may be, for example, 0.6D, 0.7D, 0.8D, or 0.9D. As the maximum Feret diameter of the central region 2c is set to be larger, the peripheral region 2p may be limited to the particle surface layer.

### Chemical Composition

The crystallite 1 may include, for example, a lithium metal composite oxide. The crystallite 1 may be made of, for example, a lithium metal composite oxide. The lithium metal composite oxide may have, for example, a layered rock salt structure. The layered rock salt structure is also referred to as “α-NaFeO₂-type structure”. The space group of the stratified rock salt type is “R-3m”. The crystallization can be determined by the powder XRD (X-ray diffraction) method.

The lithium metal composite oxide may have any chemical composition. The lithium metal composite oxide may have, for example, a composition represented by the following general formula.

Li₁₋ₐMO₂

In the formula, “−0.5≤a≤0.5” is satisfied. “M” includes at least one selected from the group consisting of Ni, Co, Mn, and Al.

The lithium metal composite oxide may be, for example, a lithium nickel composite oxide. The composition of the lithium nickel composite oxide may be represented by, for example, the following general formula. Compounds of the formulae below may also be referred to as “NCM”.

Li₁₋ₐNiₓCo_{y}Mn_{z}O₂

In the formula, “−0.5≤a≤0.5”, “0<x<1”, “0<y<1”, “0<z<1”, and “x+y+z=1” are satisfied. For example, relations such as “0.5≤x<1”, “0<y≤0.25”, and “0<z≤0.25” may be satisfied.

The composition of the lithium nickel composite oxide may be represented by, for example, the following general formula. Compounds represented by the formulae below may also be referred to as “NCA”.

Li₁₋ₐNiₓCo_{y}Al_{z}O₂

In the formula, “−0.5≤a≤0.5”, “0<x<1”, “0<y<1”, “0<z<1”, and “x+y+z=1” are satisfied. For example, relations such as “0.5≤x<1”, “0<y≤0.25”, and “0<z≤0.25” may be satisfied.

A dopant may be added to the lithium metal composite oxide. The dopant may be diffused throughout the particle or may be locally distributed. For example, dopants may be unevenly distributed on the particle surface. The dopant may be a substituted solid solution atom or an infiltrated solid solution atom. The amount of the dopant added (the material amount fraction with respect to the entire cathode active material) may be, for example, 0.01% to 5%, 0.1% to 3%, or 0.1% to 1%. One or more dopants may be added. Two or more dopants may form a complex. The dopant may include, for example, at least one selected from the group consisting of B, C, N, halogens, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and actinoids.

### Method for Producing Cathode Active Material

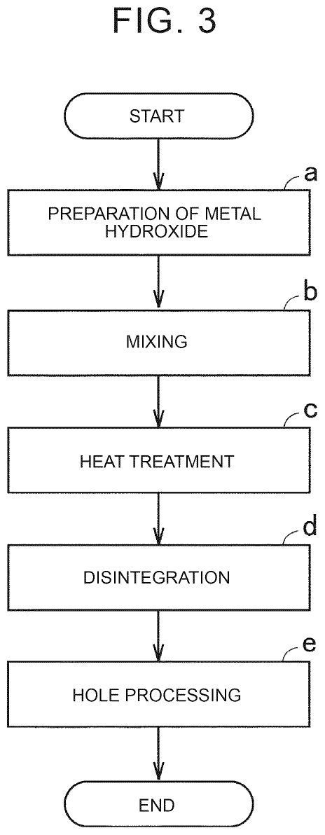

FIG. 3 is a schematic flowchart of a method for producing a cathode active material according to the present embodiment. Hereinafter, a method for producing a cathode active material according to the present embodiment is also referred to as “manufacturing method”. The manufacturing method includes “(a) preparation of metal hydroxide,” “(b) mixing,” “(c) heat treatment,” “(d) disintegration,” and “(e) hole processing.”

### (a) Preparation of Metal Hydroxide

The manufacturing method includes preparing a metal hydroxide. Metal hydroxides are precursors of lithium metal composite oxides. The metal hydroxide may be synthesized, for example, by a coprecipitation method or the like. For example, a sulfate may be provided. The sulfate may include, for example, at least one selected from the group consisting of NiSO₄, CoSO₄, MnSO₄, and Al₂(SO₄)₃. By dissolving the sulfate in water, a raw material solution is prepared. The concentration of the raw material solution may be, for example, 10% to 50% by mass fraction. By dropping the raw material solution into the alkaline aqueous solution, precipitation of the metal hydroxide can be generated. For example, the precipitate (metal hydroxide) may be recovered by filtration. After recovery, the metal hydroxide may be washed with water. After washing with water, the metal hydroxide may be dried.

### (b) Mixing

The manufacturing method includes mixing a metal hydroxide and a lithium compound to form a mixture. For example, in a mortar or the like, mixing and grinding of the material may be performed.

The “lithium compound” refers to a compound containing Li. The lithium compound may include, for example, at least one selected from the group consisting of LiOH and Li₂CO₃. The lithium compound is an Li source of the lithium metal composite oxide. The ratio of the amount of Li to the amount of the metallic hydroxide (precursor) may be, for example, 0.5 or more, 0.75 or more, 1 or more, 1.1 or more, or 1.25 or more. The ratio may be, for example, 1.5 or less, 1.25 or less, 1.1 or less, 1 or less, or 0.75 or less.

### (c) Heat Treatment

The manufacturing method includes synthesizing a lithium metal composite oxide by subjecting the mixture to a heat treatment under an oxygen atmosphere. In the manufacturing method, any heat treatment apparatus or firing furnace may be used. For example, muffle furnaces, electric furnaces, etc. may be used.

The temperature of the heat treatment may be, for example, 800° C. to 1100° C. The temperature of the heat treatment may be, for example, 900° C. or higher, or 1000° C. or higher. The temperature of the heat treatment may be, for example, 1000° C. or less, or 900° C. or less. The time of the heat treatment may be, for example, 8 hours to 12 hours. The time of the heat treatment may be, for example, 9 hours or more, 10 hours or more, or 11 hours or more. The time of the heat treatment may be, for example, 11 hours or less, 10 hours or less, or 9 hours or less.

### (d) Disintegrate

The manufacturing method includes disintegrating the lithium metal composite oxide to form crystallites. By disintegration, the level of agglomeration of crystallites can be adjusted. Disintegration may be performed such that crystallites are present as single crystallites. Disintegration may be performed such that the crystallites form a secondary particle. For example, disintegration may be performed by a crusher. Any grinder (e.g., jet mill, etc.) can be used.

### (e) Hole Processing

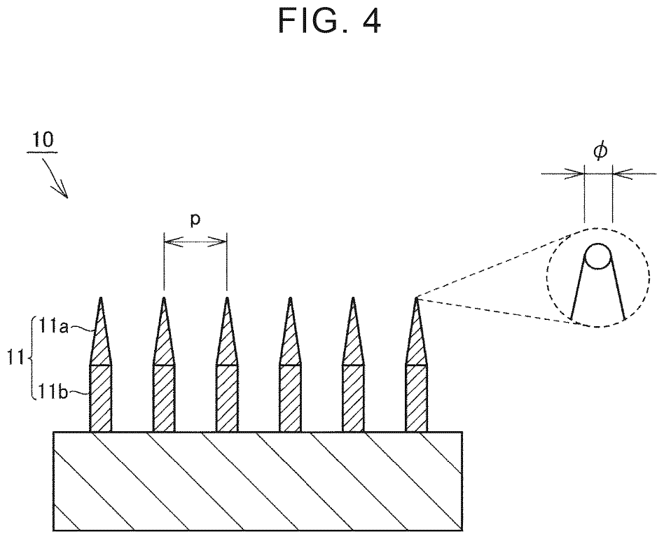

The manufacturing method includes forming open pores by pressing a needle-shaped jig into either or both of a crystallite and a secondary particle. FIG. 4 is a schematic diagram illustrating an example of a jig. The needle point holder jig 10 includes a plurality of needle-shaped jigs 11. The plurality of needle-shaped jigs 11 is arranged at a predetermined pitch (p). The pitch (p) may be, for example, 5 μm to 15 μm. The needle-shaped jig 11 includes a distal end 11a and a shank 11b. The distal end 11a may be contiguous with the shank 11b. The distal end 11a may be, for example, tapered. The length of the distal end 11a may be, for example, about 10 μm. The diameter of the distal end 11a may be, for example, 1 μm or less. The distal end diameter (φ) may be, for example, 10 nm to 500 nm. The distal end diameter (φ) may be, for example, 50 nm or more. The distal end diameter (φ) may be, for example, 400 nm or less, 300 nm or less, or 200 nm or less.

For example, by pressing the powder using the needle point holder jig 10 as an upper mold, open pores can be formed in either or both of the crystallite and the secondary particles. For example, pressing may be performed by a small hydraulic press for tablet molding or the like. The pushing force may be, for example, from 0.1 MPa to 10 MPa. The pressing force may be, for example, 0.5 MPa or more, 1.0 MPa or more, 2.5 MPa or more, 5.0 MPa or more, or 7.5 MPa or more. Pushing pressure may be, for example, 7.5 MPa below, 5.0 MPa below, 2.5 MPa below, 1.0 MPa below, or 0.5 MPa below.

### Production of Cathode Active Material

### No. 1

A raw material solution was produced by dissolving NiSO₄, CoSO₄, and MnSO₄ in ion-exchange water. In the raw material solution, the molar fraction of Ni, Co, and Mn was “Ni/Co/Mn=8/1/1.” The concentration of the raw material solution was 30% by mass fraction.

Ammonia water was placed in the reaction vessel. The inside of the reaction vessel was replaced with nitrogen while the ammonia water was stirred with the stirrer. Further, the reaction solution was formed by charging NaOH into the reaction vessel.

Precipitation (metallic hydroxide) was formed by dropping the raw material solution and ammonia-water into the reaction liquid so that the reaction liquid maintained a certain pH. The reaction solution was filtered to recover the metal hydroxide. A dispersion was formed by dispersing the metal hydroxide in ion-exchanged water. The dispersion was sufficiently stirred by the spatula. That is, the metal hydroxide was washed with water. After washing with water, the dispersion was filtered to recover the metal hydroxide. The metal hydroxide was dried at 120° C. for 16 hours to form a dry matter.

In a mortar, the dry matter (metallic hydroxide) and the lithium compound (Li₂CO₃) were mixed to form a blend.

In the muffle furnace, the mixture was subjected to a heat treatment to synthesize a lithium metal composite oxide. Conditions of the heat treatment were as follows.
Atmosphere: Oxygen atmosphere
Temperature: 800° C. to 1100° C.
Time: 10 hours

After the heat treatment, the lithium metal composite oxide was disintegrated by a jet mill. As described above, the cathode active material was produced.

### No. 2

Like No. 1, lithium metal composite oxides were synthesized. The lithium metal composite oxide was disintegrated to prepare powder. Needle point holder jig was prepared. The distal end diameter of the needle point holder jig was 100 nm. The length of the distal end was 10 μm. The diameter of the distal end was 1 μm or less. A mini-hydraulic press for tablet forming from S.T. JAPAN was prepared. The lower mold of the die set was filled with powder. The top die set is equipped with a needle point holder jig. Hole processing was performed on powder with a pushing force of P₀.

### No. 3 to No. 6

A cathode active material was produced in the same manner as No.2 except

that the pressing force was changed. The pressing force was changed to increase in the order of No. 2 (min) to No. 6 (max).

### Evaluation

A cylindrical lithium-ion secondary battery (evaluation cell) was manufactured. The structure of the evaluation cell is as follows.
Power generation element: wound type
Cathode: cathode active material/AB/PVDF=88/10/2 (mass ratio)
Anode: anode active material (natural graphite), CMC, SBR
Electrolyte: LiPF₆ (1 mol/L), EC/DMC/EM=3/4/3 (volume ratio)

The cathode and the anode were manufactured by coating a slurry on the surface of a substrate (metal foil). As a coating apparatus, a film applicator (with a film thickness adjustment function) manufactured by All Good Co. was used. After coating the slurry, the coating was dried at 80° C. for 5 minutes.

A durability test of the evaluation cell was performed. That is, charge/discharge was repeated 200 times in a range of 3.0 V to 4.1V with a constant current of 2C at room temperature. The capacity retention ratio (percentage) was determined by dividing the 200th discharge capacity by the first discharge capacity. The higher the capacity retention, the better the durability is evaluated.

### Results

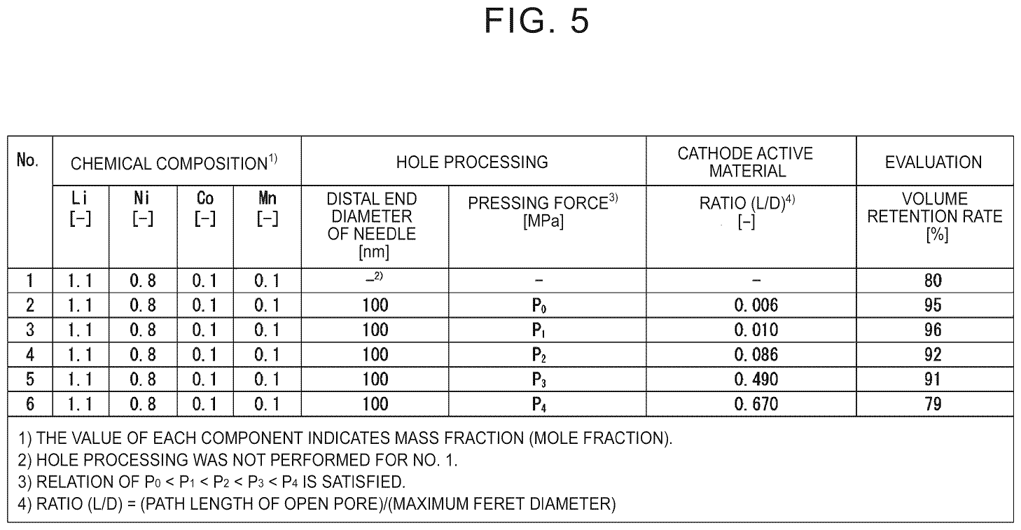

FIG. 5 is a table showing experimental results. When the relation of “0.006≤L/D<0.500” is satisfied, durability tends to be improved. The lower the ratio (L/D), the more durable it tends to be.

What is claimed is:

1. A cathode active material comprising crystallites, wherein:
the crystallites are present as either single crystallites or a secondary particle;
the secondary particle includes 2 to 20 crystallites;
each of the crystallites has a maximum Feret diameter of 1 μm or more;
either or both of the crystallite and the secondary particle have an open pore;
the open pore has an opening diameter of 10 nm to 500 nm; and
a relation of 0.006≤L/D<0.500 is satisfied,
where the L represents a path length of the open pore,
when the crystallites are present as the single crystallites, the D represents the maximum Feret diameter of the crystallite, and
when the crystallites are present as the secondary particle, the D represents the maximum Feret diameter of the secondary particle.

2. The cathode active material according to claim 1, wherein a relation of 0.010≤L/D≤0.490 is satisfied.

3. The cathode active material according to claim 1, wherein the open pore is open to a surface of the crystallite.

4. The cathode active material according to claim 1, wherein the open pore is open between the crystallites.

5. The cathode active material according to claim 1, wherein the open pore extends linearly.
